(19) United States
(12) Patent Application Publication
(10) Pub. No.: US 2005/0073269 A1
(43) Pub. Date: Apr. 7, 2005

(54) Linear motor system

(76) Inventor: Eric Anthony Lewis, Rugby (GB)

Correspondence Address: Kirschstein, Ottinger, Israel & Schiffmiller, P.C., 489 Fifth Avenue, New York, NY, 10017-6105, US

(21) Appl. No.: 10/955,998

(22) Filed: Sep. 30, 2004

(30) Foreign Application Priority Data
Oct. 7, 2003 (GB) 0323433.3

(51) Int. Cl. H02P 7/00; H01M 8/18

(52) U.S. Cl. 318/135

(57) ABSTRACT

A system comprises an energy store subsystem connected to an electronic converter subsystem, and a linear motor subsystem connectable to the electronic converter subsystem through a selector switch, the electronic converter subsystem also being connectable to an energy source through the selector switch. The electronic converter subsystem comprises a reversible power converter. In operation, the selector switch first connects the energy source to the electronic converter subsystem for charging at least one energy store in the energy store subsystem and then connects the electronic converter subsystem to the linear motor subsystem to supply power from the energy store subsystem to the linear motor subsystem. Regenerative power from linear motor braking can also be used to recharge the energy store(s) through the electronic converter subsystem. Several systems can be coupled together in parallel to a common energy source.

### FIELD OF THE INVENTION

The present invention relates to linear motors, and in particular, to linear motor systems provided with an energy store.

### BACKGROUND OF THE INVENTION

In the case of linear motor systems whose function, or one of whose functions, is to achieve rapid acceleration to a high speed of a reaction plate or carriage carrying a heavy object, it is necessary to supply large amounts of electrical energy to the motor's stator over a short period of time. The required rate of energy supply may exceed that obtainable from available energy sources, such as electrical generators or a utility supply company.

FIG. 1 diagrammatically illustrates a known type of linear motor system 1 for effecting a high rate of energy supply to the motor. The system comprises several subsystems. Thus, an energy source 10 provides energy, such as AC electrical power, to a recharge converter subsystem 12, which converts the energy from the energy source 10 to a suitable form for charging one or more energy stores in an energy store subsystem 14.

To provide a large amount of energy in a short time, the energy is stored in a way that makes it available for rapid release. The energy store(s) associated with the energy store subsystem 14 may store energy in any one or more of several ways, but conveniently for some purposes as rotational energy in one or more flywheels. In this case, the energy store subsystem must also include a means of converting electrical energy to rotational energy and vice versa, and it is convenient if this is a rotating electrical machine of the induction type. The recharge converter subsystem 12 can then comprise a thyristor converter which converts fixed frequency AC power from the energy source to variable frequency AC power for supply to the induction machine which drives—or is driven by—the flywheel.

The power available from the energy source 10 is accumulated in the energy store subsystem 14 to enable the power requirements of the linear motor subsystem 18 to be met. Once the energy store(s) in the energy store subsystem 14 is (are) fully charged, a demand signal can be received from the linear motor subsystem 18 and the power from the energy store subsystem can be passed directly to an electronic converter subsystem 16 which converts or conditions the energy to a form that can be fed to the stator of the motor in the linear motor subsystem 18.

The above-described scheme is technically feasible with present-day computer-controlled electrical technology, but it is desirable to reduce its complexity, cost, volume and weight, especially for uses of linear motors where mobility is required.

### SUMMARY OF THE INVENTION

The present invention provides reductions in one or more of complexity, cost, volume and weight of linear motor power supply systems by achieving a greater degree of integration of their subsystems.

According to the present invention, a linear motor system comprises an energy store subsystem connected to an electronic converter subsystem, and a linear motor subsystem connectable to the electronic converter subsystem through a selector switch means, the electronic converter subsystem also being connectable to an energy source through the selector switch means, the electronic converter subsystem comprising a reversible power converter for inputting power to the energy store subsystem and for supplying power from the energy store subsystem to the linear motor subsystem. In a first configuration of the selector switch means, the energy source is connected to the electronic converter subsystem for charging at least one energy store in the energy store subsystem and, in a second configuration of the selector switch means, the electronic converter subsystem is connected to the linear motor subsystem to supply power from the energy store subsystem to the linear motor subsystem.

It will be appreciated from the above that the invention achieves a greater degree of integration by using a reversible power converter in the electronic converter subsystem so that it has the ability to both recharge the energy store subsystem and supply power to the linear motor subsystem, thereby eliminating the need for a recharge converter subsystem. Preferably, the reversible power converter is of the pulse width modulated (PWM) type.

The selector switch means may be of the electromechanical type, comprising, for example, either a three pole switch, or a pair of two-pole switches. It will be evident to the skilled person that to handle large powers, the switches must be fast-acting, suitably insulated, and provided with arc-extinguishing technology, if necessary. Such switches are known in the electrical supply industry.

In a second aspect of the invention, a plurality of such linear motor systems are coupled together, each system comprising respectively an energy store subsystem, an electronic converter subsystem, selector switch means and a linear motor subsystem, the plurality of linear motor systems being connected in parallel through their respective selector switch means to a single energy source acting as a common facility for the plurality of linear motor systems. The linear motor subsystems can comprise either separate linear motors operated in parallel, or serially arranged segments of the same linear motor.

The invention also provides a method of operating a linear motor system like that described above, comprising repeating the following steps in sequence:
a) charging the energy store subsystem by connecting the electronic converter subsystem to the energy source through the selector switch means, and
b) supplying power from the energy store subsystem to the linear motor subsystem by connecting the electronic converter subsystem to the linear motor subsystem through the selector switch means. Additionally, after supplying power from the energy store subsystem to the linear motor subsystem in step (b), but before repeating step (a), regenerative power from the linear motor subsystem may be fed back to the energy store subsystem through the selector switch means and the electronic converter subsystem.

Further aspects of the invention will be apparent from the following description and the appended claims.

### BRIEF DESCRIPTION OF THE DRAWINGS

Exemplary embodiments of the invention will now be described with reference to the accompanying drawings, in which:

FIG. 1 diagrammatically illustrates a prior art arrangement of subsystems constituting a linear motor system;

FIG. 2 diagrammatically illustrates a linear motor system according to the present invention;

FIG. 3 is a simplified circuit diagram of a reversible electric power converter suitable for use in the invention;

FIG. 4 shows how linear motor systems according to the present invention can be connected together in parallel with each other; and

FIG. 5 diagrammatically illustrates a linear motor system similar to that in FIG. 2, but provided with an alternative selector switch arrangement.

### DETAILED DESCRIPTION OF THE PREFERRED EMBODIMENTS

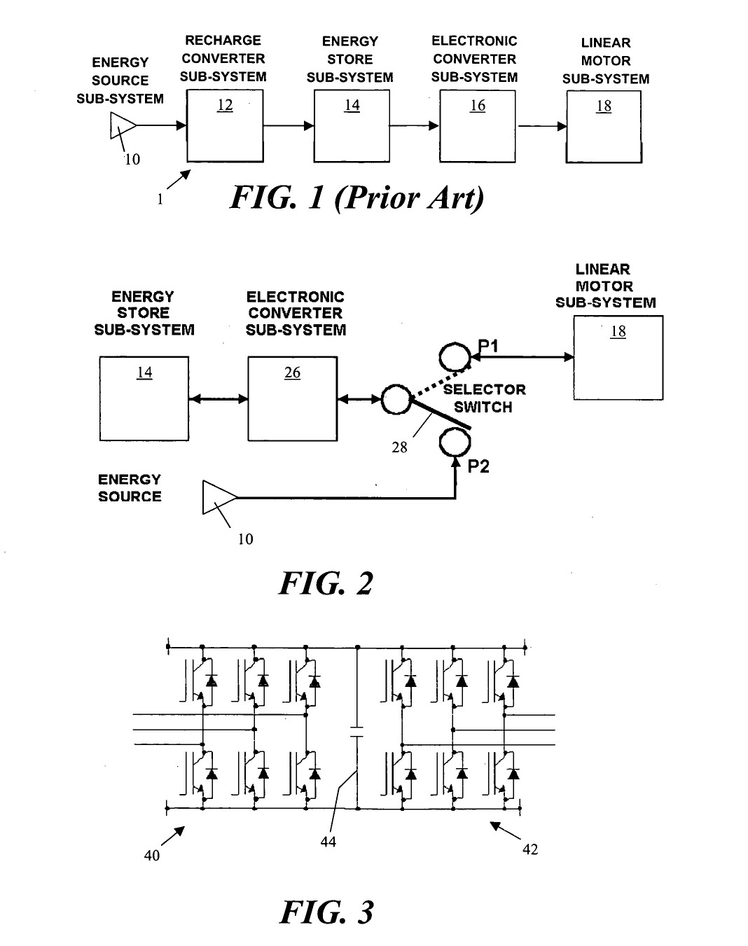

Referring to FIG. 2, those subsystems which are the same or very similar to those in FIG. 1 are given the same reference numbers. However, it will be seen that compared with FIG. 1, a different type of electronic converter system 26 has been introduced, the recharge converter subsystem has been eliminated, and a simple two-way selector switch 28 has been inserted immediately before the linear motor subsystem 18. Switch 28 controls flow of power from the energy source 10 to the energy store subsystem 14, from the energy store subsystem 14 to the linear motor subsystem 18, and from the linear motor subsystem back to the energy store subsystem. In all three cases, power flow is handled by the electronic converter subsystem 26.

The system works by initially setting the selector switch 28 to position P2. The electronic converter subsystem 26 can then pass power from the energy source 10 to the energy store subsystem 14 to put the required energy into the energy stores associated with that subsystem. After the energy stores have been charged, the selector switch 28 can be electronically commanded by a power demand signal to flip to position P1, so that the electronic converter subsystem 26 can pass power from the energy store subsystem 14 to the linear motor subsystem 18.

While the selector switch 28 is set at position P1, and after operation of the linear motor has been initiated, the power flow through the system is advantageously reversed by sending regenerative power, obtained from braking of the linear motor, back to the energy store subsystem 14 through the electronic converter subsystem 26.

Finally the sequence is repeated by re-setting the selector switch 28 to position P2 so that the energy store subsystem 14 can be charged with the required energy ready for the next duty cycle.

The type of equipment used for the energy store subsystem 14 is well known to those skilled in the art and can comprise any available energy storage device, including—but not limited to—the following technologies:
Rotary energy stores.
Battery energy stores.
Super-conducting magnetic energy stores.
Super-capacitor energy stores.

A rotary energy store may be preferred for some uses of the invention. For example, in one possible rotary energy store subsystem 14, the rotational energy of a massive flywheel is converted to electrical energy by a pulse alternator and is then passed to the electronic converter subsystem 26.

The type of equipment used for the energy source 10 is well known to those skilled in the art and can comprise any available energy source, including—but not limited to—the following technologies:
Power from a networked utility supply.
Power from a local generator, such as a gas turbine linked to an electrical generator.

The type of equipment used for the linear motor subsystem 18 is well known to those skilled in the art and can comprise any available linear motor, including—but not limited to—the following technologies:
Linear induction motors.
Linear synchronous motors.
Wound rotor linear motors.

A linear induction motor may be preferred for some uses of high power linear motors. This may comprise stator segments having windings, with a reaction plate riding as a carriage on rails or the like.

The type of equipment used for the selector switch 28 is well known to those skilled in the art and can comprise any suitable available switch, including—but not limited to—the following technologies:
One mechanical switch with a changeover action.
Two mechanical switches forming the same circuit.
One electronic switch with a changeover action.
Two electronic switches forming the same circuit

A configuration involving two mechanical switches forming the same circuit may be preferred as shown in FIG. 5. Here, each switch 581, 582 may be operated independently or synchronously, as desired, for extra flexibility in use of the system.

The type of equipment used for the electronic converter subsystem 26 can be any suitable bi-directional (reversible) electronic power converter, but a pulse-width modulated (PWM) type of converter is preferred, as shown diagrammatically in FIG. 3. Note that the converter is a DC link type, shown here idealized and in simple form. In practice, full converter circuits are more complicated, incorporating timing circuits, protection circuits and snubber circuits; however, such converters are available from several manufacturers.

The circuit shown in FIG. 3 uses two three-phase inverter bridges 40, 42 with a DC link 44 and pulse width modulation (PWM) control. This is a standard ALSTOM-manufactured power converter that converts AC input currents and voltages into independently controlled output currents and voltages, the system being symmetrical so that power can flow in either direction. A three-phase system is shown, but for certain types of energy store subsystems 14, the interface with the electronic converter subsystem 26 will be DC and only two input phases will be needed on the converter bridge circuit which interfaces with the energy store.

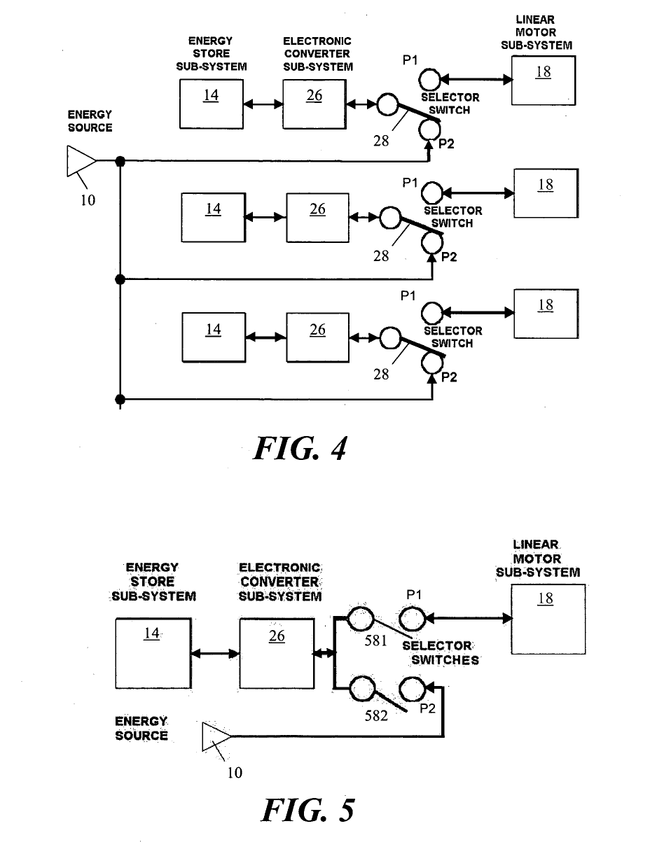

It is possible to couple together two or more systems like the one shown in FIG. 2 (or FIG. 5) to produce an arrangement like that shown in FIG. 4, each system comprising a selector switch 28, an energy store subsystem 14, an electronic converter subsystem 26 and a linear motor subsystem 18. The systems are connectable in parallel through their respective selector switches to a single energy source 10 which acts as a common facility for the group of systems, thereby reducing costs. The linear motor subsystems can comprise separate linear motors operated in parallel, in which case the selector switches 28 may be operated independently of each other. Alternatively, the linear motor subsystems can comprise serially arranged segments of the same linear motor, the selector switches 28 then being operated in rapid sequence to deliver the electrical energy to the successive segments.

1. A linear motor system, comprising: an energy store subsystem for delivering power to a linear motor subsystem via an electronic converter subsystem, the electronic converter subsystem comprising a reversible power converter, and the linear motor subsystem being connectable to the electronic converter subsystem through a selector switch means, the electronic converter subsystem also being connectable to an energy source through the selector switch means, the electronic converter subsystem being capable of inputting power to the energy store subsystem and of supplying power from the energy store subsystem to the linear motor subsystem.

2. The linear motor system according to claim 1, wherein, in a first configuration of the selector switch means, the energy source is connected to the electronic converter subsystem for charging at least one energy store in the energy store subsystem and, in a second configuration of the selector switch means, the electronic converter subsystem is connected to the linear motor subsystem to supply power from the energy store subsystem to the linear motor subsystem.

3. The linear motor system according to claim 1, in which the selector switch means is a three-pole switch.

4. The linear motor system according to claim 1, in which the selector switch means comprises a pair of two-pole switches.

5. The linear motor system according to claim 1, in which the reversible power converter is of a pulse width modulated (PWM) type.

6. A method of operating a linear motor system, the system comprising an energy store subsystem connected to an electronic converter subsystem, and a linear motor subsystem connectable to the electronic converter subsystem through a selector switch means, the electronic converter subsystem also being connectable to an energy source through the selector switch means, the electronic converter subsystem comprising a reversible power converter, the method comprising repeating the following steps in sequence:
a) charging at least one energy store in the energy store subsystem by connecting the electronic converter subsystem to the energy source through the selector switch means, and
(b) supplying power from the energy store subsystem to the linear motor subsystem by connecting the electronic converter subsystem to the linear motor subsystem through the selector switch means.

7. The method according to claim 6, in which after supplying power from the energy store subsystem to the linear motor subsystem in step (b), but before repeating step (a), regenerative power from the linear motor subsystem is fed back to the energy store subsystem through the selector switch means and the electronic converter subsystem.

8. An apparatus comprising: a plurality of linear motor systems, each linear motor system comprising a linear motor subsystem, an energy store subsystem, and an electronic converter subsystem for feeding power from the energy store subsystem to the linear motor subsystem, selector switch means being provided for connecting the electronic converter subsystem to the linear motor subsystem, the plurality of linear motor systems being connectable in parallel through their respective selector switch means to a single energy source acting as a common facility for the linear motor systems.

9. The apparatus according to claim 8, in which the linear motor subsystems comprise separate linear motors operated in parallel with each other.

10. The apparatus according to claim 8, in which the linear motor subsystems comprise serially arranged segments of the same linear motor.
